(19) United States
(12) Patent Application Publication
(10) Pub. No.: US 2005/0105395 A1
(43) Pub. Date: May 19, 2005

(54) Method and apparatus for determining freshness for a brewed beverage

(76) Inventor: Paul Harrison, Oakville (CA)

Correspondence Address: KENNETH L. MITCHELL;(WOODLING, KROST AND ROST), 9213 CHILLICOTHE ROAD, KIRTLAND, OH, 44094, US

(21) Appl. No.: 10/716,925

(22) Filed: Nov. 19, 2003

(51) Int. Cl. G04F 10/00; G04B 47/00; G04F 1/00

(52) U.S. Cl. 368/10; 368/108

(57) ABSTRACT

A brewed beverage timer/freshness indicator system. A timer device is adapted for attaching to a decanter or beverage container. The timer device executes a brew freshness timing cycle. The timing cycle is initiated by depressing a reset button on the timer device. In another embodiment, the timer device includes a communication interface for receiving a start signal to initiate the freshness timing cycle. The timer device includes a pour switch and a controller for recording each time the container is poured. The communication interface also provides the capability for transmitting status information or data, including timing information and pour information, from the timer device to a data processing unit.

### FIELD OF THE INVENTION

The present invention relates to beverage brewing systems and more particularly to an apparatus and techniques for tracking and indicating the progress of brewed coffee or other types of brewed beverages.

### BACKGROUND OF THE INVENTION

Coffee is enjoyed by many people all over the world. However, as many coffee lovers know, the quality can vary greatly especially when the coffee is left on the warmer for an extended period time. Coffee beans absorb aromas and once it is mixed with water, the quality and taste quickly begins to deteriorate. The longer the coffee stays on the warmer, the more its taste deteriorates. This phenomena, is caused by an acid buildup in the brewed liquid.

### BRIEF SUMMARY OF THE INVENTION

The present invention provides a decanter device that that attaches to a coffee decanter, coffee pot or any container holding the brewed liquid, such as a Thermos™ type container. The decanter device includes electronics for tracking and providing a freshness indication for coffee brewed using a coffee maker, or other types of brewed or heated beverages, such as tea, cider and hot chocolate.

According to one aspect, the decanter device includes a number of indicators to indicate the amount of time that has passed since a pot of coffee has been brewed. According to another aspect, the device allows the user to program the times for each stage of the indicated process. Other aspects of the decanter device include display and functional features such as LCD, LED, Audio indicators and Alarms. Operation of the decanter device is coordinated with the operation of the brew system, for example, in a coffee maker pushing the brew button on the coffee maker initiates Brew and Freshness timing functions.

In another aspect, the present invention provides a device which is attached to the beverage brew system, for example, a coffee maker, and the brew system device communicates with the decanter device to track the brew cycle and standing time in addition to other information.

In another aspect, the decanter device may be operated in manual mode or in a wireless mode. In manual mode, the decanter device is activated by manually pushing/depressing a reset button. In wireless mode, the decanter device works in conjunction with the device on the brew system (e.g. a coffee maker) via a wireless communication channel. Using the communication channel, the coffee maker device sends commands, such as a reset command, to the decanter device, in response a brew cycle being initiated. In a further aspect, the wireless communication channel is used by a computing device, such as a computer or personal digital assistant (PDA), to send commands, status and other information requests to the decanter device and/or brew system device. The information is then available of analysis and further processing, to derive performance data such as number of pots brewed, time to fill, time between refills.

According to one aspect, the decanter device includes one or more light emitting diodes (LED's) which provide a visual indication of the brew, freshness and expiry stages of the brewed beverage. An audible response may be provided instead of or in addition to the visual response from the LED's. The LED's are controlled by a microprocessor according to timer functions which are executed under program control. As the decanter device nears its end of life, the LED's go into a sequence of flashing patterns. This sequence is designed to notify the user that the battery is about to expire. After the battery has been exhausted, the decanter device is easily replaced using a clip-on mechanism.

According to another aspect, there is provided the capability for a customer to pre-order or customize the configuration of the microprocessor for the brew, freshness or expiry times that best suit the customer's intended or operating standards.

According to another aspect, there is provided the capability for a customer to order labeling or custom colours that identify the timer configuration based on specific timing needs or specific coffee blends.

In a first embodiment, the present invention provides a timer device for a container holding a beverage, the timer device comprises: a base member for coupling to the container; a housing member adapted for coupling to the base member; and a controller contained in the housing member, and including a timer component for measuring an elapsed time for the beverage, wherein the timer component includes an input for receiving a start signal; and the controller includes a power supply input.

In a second embodiment, the present invention provides a system for monitoring a brewed beverage dispensed from a container, the system comprises: a timer device including, a housing for coupling to the container; a controller contained in the housing, and including a timer component for measuring an elapsed time for the beverage, wherein the timer component includes an input for receiving a start signal; a communication interface coupled to the controller, and the controller includes a component for processing command signals received via the communication interface; and a controller module includes, a controller device has an input port coupled to a fill switch, the fill switch outputs a signal, the controller device has a component responsive to the fill switch signal for generating the start signal for the timer device; a communication interface coupled to the controller device, and the controller device includes a component for transmitting the start signal to the timer device.

In another embodiment, the present invention provides a device for monitoring a beverage in a container, the device comprises: a base member for coupling to the container; a housing member adapted for coupling to the base member; a circuit contained in the housing member, and including a timer component for determining a freshness state for the beverage, wherein the timer component includes an input responsive to a start signal; and the circuit includes a power supply input.

Other aspects and functions of the present invention will become apparent to those ordinarily skilled in the art upon review of the following description of specific embodiments of the invention in conjunction with the accompanying drawings.

### BRIEF DESCRIPTION OF THE DRAWINGS

Reference is next made to the accompanying drawings which show, by way of example, embodiments of the invention and in which:

FIG. 1 shows in diagrammatic form a beverage brew system in accordance with the present invention;

FIG. 2 shows in block diagram form a decanter device for the beverage brew system of FIG. 1;

FIG. 3 shows a block diagram form a brew system device for the beverage brew system of FIG. 1;

FIGS. 4(a) to 4(d) show in diagrammatic form a decanter clip in accordance with the present invention;

FIGS. 5(a) and 5(b) show in diagrammatic form embodiments of a user label for the decanter clip of FIG. 4;

FIG. 6 shows in flow chart form a coffee brew timer process in accordance with the present invention;

FIG. 7 shows in flow chart form a coffee brew timer process according to another embodiment of the invention; and

FIG. 8 shows in flow chart form a coffee brew timer process according to a further embodiment of the invention.

### DETAILED DESCRIPTION OF THE EMBODIMENTS

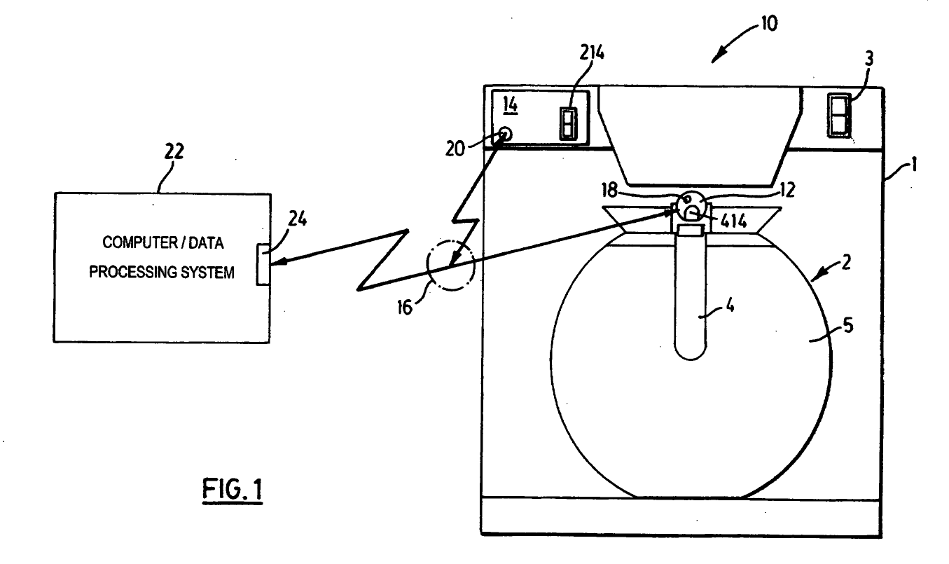

Reference is first made to FIG. 1 which shows in block diagram form a beverage brewing system 10, for example, a coffee brewing system, in accordance to the present invention. While the present invention is described in the context of a coffee brewing system, it will be appreciated that the system has applicability to other types of brewing or beverage freshness monitoring systems.

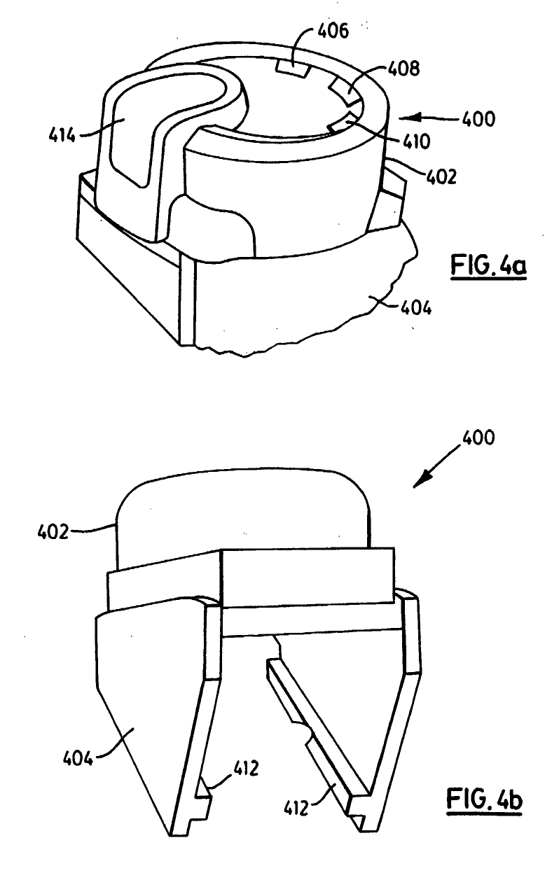

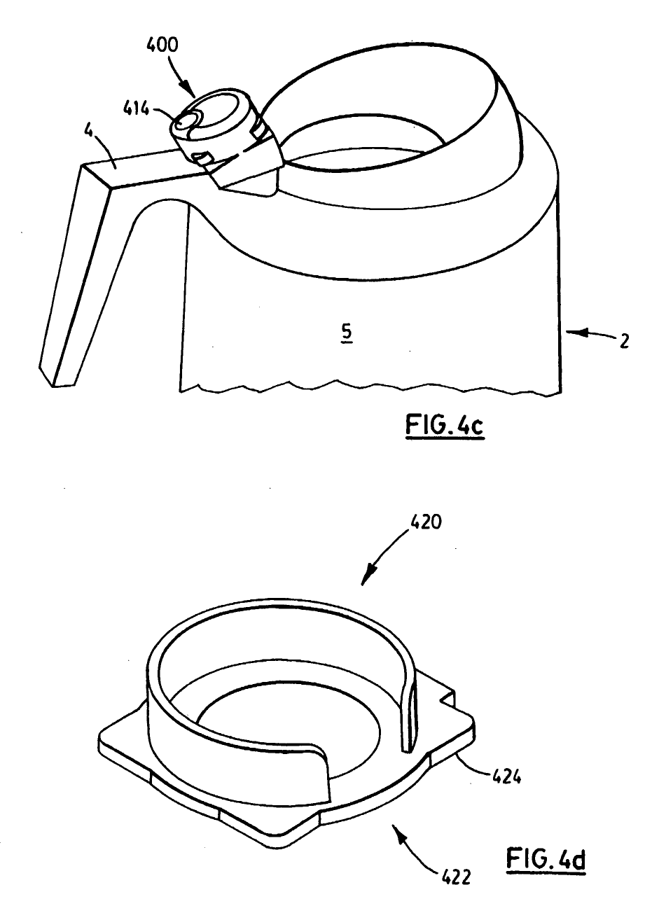

The coffee brewing system 10 comprises a coffee maker 1 with one or more coffee pots or decanters 2, a coffee decanter device 12 and a coffee maker device 14. The coffee decanter device 12 is attached to the handle 4 of the coffee pot 2, or to a thermal type server that is used with the coffee maker 1 (for example as described below with reference to FIGS. 4(c) and 4(d)). The coffee maker device 14 may be attached externally to the coffee maker 1 or integrated with the coffee maker 1.

In accordance with one embodiment, the coffee decanter device 12 is operated manually and independently of the coffee maker device 14. This embodiment of the coffee decanter device 12 is referred to as the non-wireless coffee decanter device and its operation is termed manual mode.

In accordance with another embodiment, the coffee decanter device 12 is operated in conjunction with the coffee maker device 14 via a communication link 16. As will be described in more detail below, the communication link 16 comprises a wireless link, e.g. a radio link or an infrared link, and the coffee decanter device 12 and the coffee maker device 14 each include a wireless transceiver, indicated by references 18 and 20, respectively. This embodiment of the coffee decanter device 12 is referred to as the wireless coffee decanter device, and its operation is termed wireless mode.

In another aspect, a computer 22 or other type of data processing system, such as a PDA device, is equipped with a wireless transceiver 24 which is compatible with the wireless transceivers 18 and 20 on the coffee decanter device 12 and the coffee maker device 14, respectively. The computer system 22 communicates with the coffee decanter device 12 and the coffee maker device 14 using a communication protocol which may comprise a standard communication protocol, such as blue tooth, or a proprietary host-client polling configuration which provides the functionality as described in more detail below. Under software control, the computer system 22 operates to gather information from the coffee decanter 12 and the coffee maker 14 devices and generate statistics and other types of system data and operational data. The computer system 22 may also be programmed to perform control functions such as those described below.

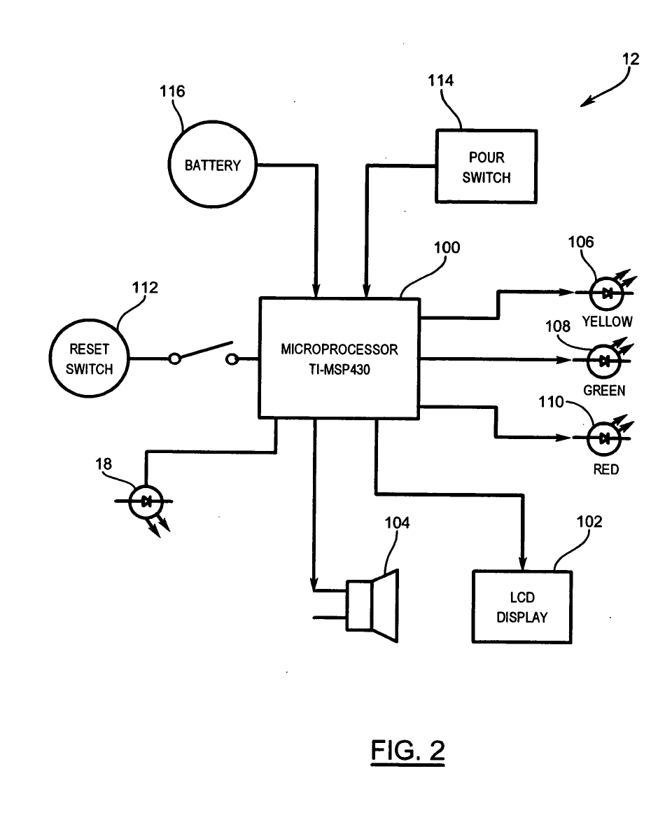

Reference is made to FIG. 2 which shows the coffee decanter device 12 in more detail. The coffee decanter device 12 comprises a controller 100, a liquid crystal display (LCD) module 102, a buzzer 104, a yellow light emitting diode (LED) 106, a green LED 108, a red LED 110, a reset switch 112 and a pour switch 114. The coffee decanter device 12 is powered by a battery 116. As described above, the coffee decanter device 12 may include the wireless transceiver 18 for the communication link 16 with the coffee maker device 12 and/or the computer system 22.

The coffee decanter device 12 is intended to be attached or coupled to the coffee pot or decanter 2 as shown in FIG. 4(c). The coffee pot decanter 2 comprises a handle 4 and a glass decanter 5. Referring to FIGS. 4(a) and 4(b), the coffee decanter device 12 is contained or housed in a decanter clip indicated by reference 400. The decanter clip 400 comprises a housing or enclosure 402 and a clip 404. The housing 402 holds the electronic components for the device 12 as described above with reference to FIG. 2. The housing 402 may be permanently secured to the clip 404 or according to another embodiment detachably coupled, for example, snap fitted, to the clip 404. The clip 404 as shown in FIG. 4(b) includes clip edges or flanges 412 which engage contour edges on the handle 4 of the coffee pot 2. According to another embodiment, the clip 404 may be formed as part of the handle 4 and the housing 402 is snap fitted in the integrated clip 404.

According to another aspect, the coffee decanter device 12 is modified with a base 420 as shown in FIG. 4(d) to attach or couple the device 12 to a thermal type server. The thermal server may be used for a variety of hot beverages, including coffee, tea and cider. The base 420 is coupled to the housing or enclosure 402 (FIGS. 4(a) to 4(c)), and takes the place of the clip 404. The base member 420 has a bottom surface 422 to which is affixed a section of double-sided tape 424, or other suitable adhesive with a peel-away tab or the like. The decanter device 12 (i.e. housing 402 and base member 420) is affixed to the thermal server using the double-sided adhesive tape 424 or other adhesive strip. Once attached to the thermal server, the coffee decanter device 12 is manually actuated or automatically activated via the wireless option mode as described above. In wireless mode, configuration data may be sent to readjust the brew, freshness and expiry cycles as may be required for special blends or different beverages.

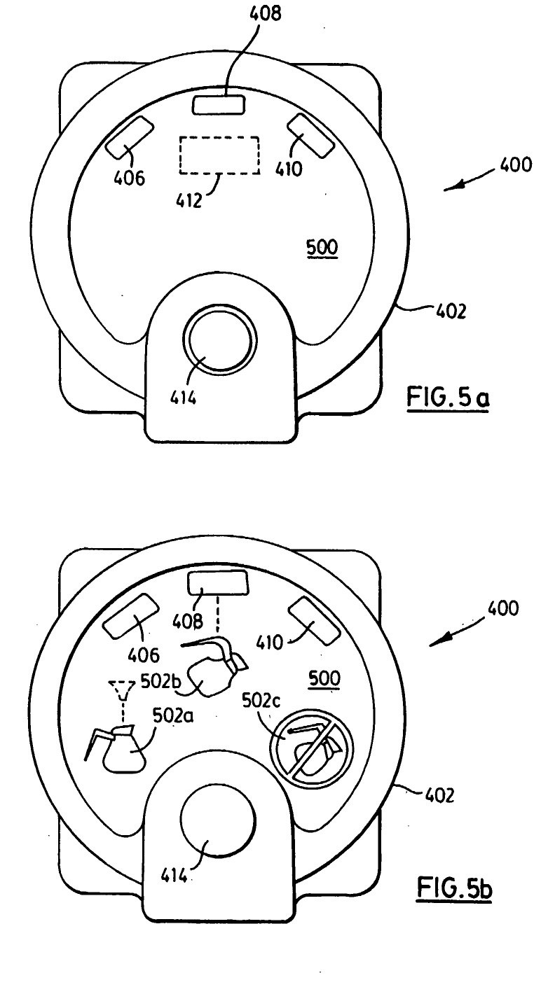

As shown in FIG. 4(a) and FIGS. 5(a)-5(b), the housing 402 includes a top face or surface 403 having openings or windows 406, 408, 410 for the LED's 106, 108 and 110, respectively. For an infrared communication link 16, an opening 412 is provided for an infrared emitter/detector. As also shown in FIGS. 4(a) to 4(c) and FIGS. 5(a) to 5(b), the housing 402 for the decanter clip 400 includes a button or actuator 414 for activating the reset switch 112 (FIG. 2) in the coffee decanter device 12. For a radio frequency (RF) communication link, the openings for the infrared emitter/detector may be omitted. As compared to infrared, radio frequency allows multiple communication channels between multiple devices.

As also shown in FIGS. 5(a) and 5(b), the decanter clip 400 may include a faceplate indicated generally by reference 500. The faceplate 500 as depicted in FIG. 5(a) may be configured with customer specific labeling, such as, advertising information, for example, the company name of the manufacturer of coffee maker or decanter pots, or the company name of a coffee store or chain. In another embodiment, the faceplate 500 is configured with symbol image labeling. As depicted in FIG. 5(b), the symbol image labeling comprises icons or symbols 502, indicated individually as 502a, 502b and 502c. The first icon 502a is read in conjunction with the red LED 406 and indicates that a brew cycle is in progress for the coffee in the pot 1. The second icon 502b is read in conjunction with the green LED 408 and indicates that the coffee is brewed and of suitable freshness for consumption. The third icon 502c is read in conjunction with the yellow LED 410 and indicates that the coffee is beyond the desired or preprogrammed freshness or dispense period and should therefore be discarded from the pot 2. The faceplate 500 may be made of a clear plastic so that it can be custom silk screened with the standard Symbol Timer icons 502 or a specific customer's company logo. For an infrared communication link 16, the opening 412 for the infrared emitter/detector is arranged so that the customer name labeling or icons 502 do not interfere.

The components for the decanter clip 400 may be manufactured from plastic and hermetically sealed thus allowing for safe use in the Food and Beverage Industry.

Referring back to FIG. 2, the controller 100 for the decanter device 12 is implemented using a microcontroller or microprocessor based device, such as a TI MSP4301101A microprocessor by Texas Instruments Inc. The MSP4301101A is a low power device. The microprocessor 100 is suitably programmed and executes a firmware program stored in memory which operates to provide the functionality for the coffee decanter device 12 as described.

The LCD module 102 is implemented using a low power LCD reflective type display device. Under the control of the microprocessor 100, the LCD module 102 provides a visible indication of the time since the coffee was ‘Brewed’ or the ‘Expire’ time for the brew freshness. The time is displayed in minutes. In some applications, the LCD module 102 is-omitted and the freshness indicator is provided by the LED's 106 to 110.

The buzzer 104 comprises a piezo-electric device or speaker. The microprocessor 100 uses the buzzer 104 to give an audible indication of the various stages in the brew and freshness timer cycles.

The LED's 106, 108, 110 are implemented using high lumens, low power surface mount devices. The LED's 106, 108, 110 are coupled to an output port on the microprocessor 100, and under the control of firmware are activated by the microprocessor 100 to provide visible status of the brew and freshness timer cycles as described in more detail below.

The reset switch 112 provides a hard reset to the microprocessor 100 and is activated by pushing the external button 414 on the decanter clip 400 (FIG. 4(a)). The reset causes the microprocessor 100 to reinitialize and begin executing the firmware program and timer cycles from the beginning as described in more detail below.

The pour switch 114 is implemented using a ball or level (mercury) switch device. The pour switch 114 is coupled to an input port on the microprocessor 100 and generates a signal for the microprocessor 100 indicating that the coffee pot or decanter 2 has been tilted to pour. The output from the pour switch 114 may be used as part of the statistics gathering operations. For example, time readings or measurements corresponding to the length of time the decanter 2 was tilted in pouring position are gathered. According to one aspect, the gathered data is used to determine the number of cups that were poured from the decanter 2 per brewing cycle or cycles.

The battery 116 serves as the power supply for the microprocessor 100 and the LCD module 102 and other electronic circuitry for the decanter device 12. The battery 116 is implemented using a coin cell type battery. Such a battery device is compact and provides adequate power over the operating life of the decanter device 12, which is estimated to be at least one year operating 24 hours/7 days a week with circuitry utilizing the TI MSP4301101A device for the microprocessor 100.

As described above with reference to FIG. 1, the coffee decanter device 12 can include a wireless transceiver 18. The wireless transceiver 18 is coupled to an input/output port or bidirectional communication port on the microprocessor 100. The microprocessor 100 uses the wireless transceiver 18 to send and retrieve information to and from the coffee maker device 14 and to or from the computer system 22, i.e. personal computer or PDA device. Implementation of the wireless transceiver 18 is dependent on the type of communication link 16. The wireless transceiver 18 may be implemented using Infrared devices or radio frequency devices. Information collected over the wireless communication link 16 may be used, for example, for productivity or marketing analysis. Data which may be transmitted includes configuration data to the coffee decanter and thermal servers to re-adjust the brew, freshness and expiry cycles as may be required for special blends or different beverages. Data which may also be transmitted across the communication link 16 includes the number of pots of coffee brewed/dispensed in each of the coffee pots 2, the total number of pots of coffee brewed by the coffee maker system over the course of a day, week, month, or year. Information collection may also be refined to tracking the types of coffee being brewed in designated ones of the coffee pots 2.

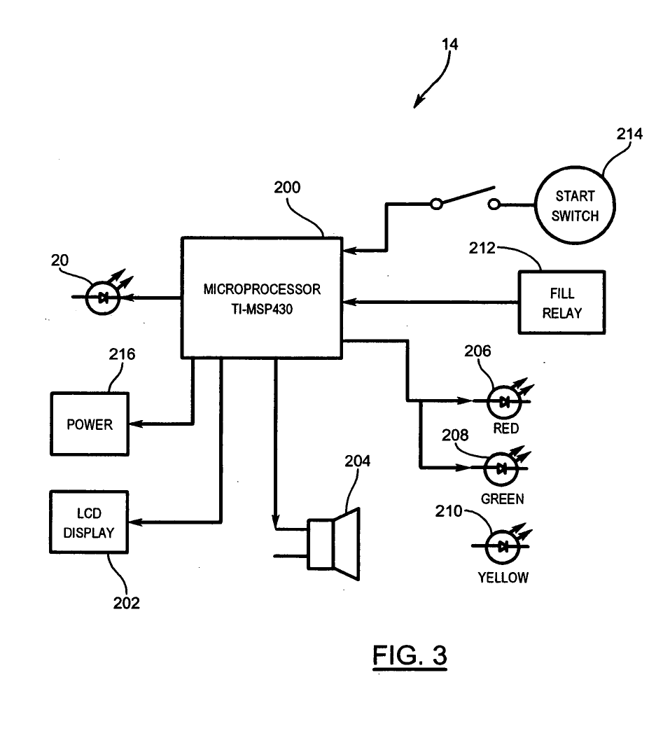

Reference is next made to FIG. 3, which shows the coffee maker device 14. The coffee maker device 14 also includes a controller 200, a LCD module 202, a buzzer device 204, a red LED 206, a green LED 208, a yellow LED 210, a fill relay 212, a start switch 214, and a power supply module 216. For the wireless communication link 16, the coffee maker device 14 includes the wireless transceiver 20 as described above.

The controller 200 is implemented using a low power microcontroller or microprocessor based device, such as a TI MSP4301101A microprocessor by Texas Instruments Inc. The microprocessor 200 is suitably programmed and executes a firmware program stored in memory which operates to provide the functionality for the coffee maker device 14 as described in more detail below.

The LCD module 202 is implemented using a low power LCD reflective type display device. Under the control of the microprocessor 200, the LCD module 202 provides a visible indication of the time since the coffee was ‘Brewed’ or the ‘Expire’ time for the brew freshness. The time is displayed in minutes.

The buzzer 204 comprises a piezo-electric device or speaker. The microprocessor 200 in the coffee maker device 14 uses the buzzer 204 to give an audible indication of the various stages in the brew and freshness timer cycles.

The LED's 206, 208, 210 are implemented using high lumens, low power surface mount devices. Similarly to the coffee decanter device 12, the LED's 206, 208, 110 are coupled to an output port on the microprocessor 200, and under the control of firmware are activated by the microprocessor 200 to provide visible status of the brew and freshness timer cycles, for example, mirroring the operation of the coffee decanter device 12 as described in more detail below.

The fill relay switch 212 provides a start signal for the timer processes/functions in the coffee decanter device 12 and the coffee maker device 14. The fill relay switch 212 has an output which is coupled to an input port on the microprocessor 200. The fill relay switch 212 is located on the coffee maker and actuation of the fill relay 212 starts the timer processes.

The start/activation switch 214 is coupled to a ‘Brew’ or ‘Start Brew’ button (indicated by reference 3 in FIG. 1) on the coffee maker 1. The start/activation switch 214 has an input coupled to the Start Brew button 3 (FIG. 1) and an output coupled to an input port on the microprocessor 200. The start/activation switch 214 is activated when the Start Brew button 3 is pushed, and an input signal is generated for the microprocessor 200. The microprocessor 200 uses the input signal to start execution of the firmware program and the operations associated with the timing processes and functions as described in more detail below.

The power supply module 216 provides a power source for the microprocessor 200 and the LCD module 202 and other electronic circuitry for the coffee maker device 14. The power supply module 216 may be implemented as a line powered device, for example, receiving a DC or AC feed from the power supply for the coffee maker 1 (FIG. 1). The power supply module 216 may also be implemented using a battery, for example, a 9-Volt battery.

As described above for the coffee decanter device 12, the coffee maker device 14 can include a wireless transceiver 20. The wireless transceiver 20 is coupled to an input/output port or bi-directional communication port on the microprocessor 200. The microprocessor 200 uses the wireless transceiver 20 to send and retrieve information to and from the coffee decanter device 12 and to or from the computer system 22. Implementation of the wireless transceiver 20 is dependent on the type of communication link 16. The wireless transceiver 20 may be implemented using Infrared devices or radio frequency devices. Information collected over the wireless communication link 16 can be used for productivity or marketing analysis. Data which may be transmitted across the communication link 16 includes the number of pots of coffee brewed/dispensed in each of the coffee pots 2, the total number of pots of coffee brewed by the coffee maker 1 over the course of a day, week, month, or year. Information collection may also be refined to tracking the types of coffee being brewed in designated ones of the coffee pots 2.

As described above with reference to FIG. 2, the principal functions performed by the coffee decanter device 12 are timing functions for tracking and indicating the freshness of a brewed beverage, for example, the coffee in the pot 2. The timer functions associated with the operation of the coffee decanter device 12 are now described in more detail.

The timer function in the coffee decanter device 12 is activated either by pressing the Reset button 414 (FIG. 1) or by sending a command or control signal via the wireless communication link 16 from the coffee maker device 14 (FIG. 1). Manually pressing the Reset button 414 actuates the reset switch 112 (FIG. 2) which resets the microprocessor 100 in the coffee decanter device 12 and starts execution of the timer functions under firmware. For wireless operation, pushing the Brew button 3 (FIG. 1) on the coffee maker 1 generates an input signal for the microprocessor 200 in the coffee maker device 14, which then under firmware control transmits commands or control signals to the wireless transceiver 18 of the coffee decanter device 12. The command is received and decoded by the microprocessor 100 and the timer function is initiated by the firmware.

According to this aspect of the invention, the LED's 106, 108, 110 in the coffee decanter device 12 (and the LED's 206, 208, 210 in the coffee maker device 14) indicate the following stages in a beverage cycle.
Stage 1: Brew Stage.
Stage 2: Dispense/Freshness Stage
Stage 3: Expiry Stage
Stage 4: Inactive Stage
   In addition, there is a Stage 5 which signifies the ‘End of Battery Life’ for the battery 116 in the coffee decanter device 12.

The Inactive Stage is indicated when all of the LED's 106, 108, 110 are off. In one aspect of the program, the timer function for the coffee decanter device 12 (and the coffee maker device 14) can be completely reset to the inactive stage at any point during its cycle. This is done by pressing the reset button 414 and holding it down for 4 seconds, or by receiving a Reset signal via the wireless communication link 16 from the coffee maker device 14.

The Brew stage is indicated by the yellow (amber) LED 106 (and LED 206 on the coffee maker device 14). The Brew Stage timer function is initiated by manually pressing the Reset button 414, or by the reception of a wireless command from the coffee maker device 14. Actuation of the Reset button 414 causes the yellow 106, the red 108 and the green 110 LED's to illuminate immediately and remain on for 125 ms. The yellow LED 106 then stays on and blinks every 2 seconds indicating continuation of the Brew stage. The exact duration of the various timer periods is dependent on pre-programmed values in the firmware and the selection of those values for a particular customer or application. The Brew cycle is by-passed by pressing and holding the Reset button 414 for 2 seconds. When this is done, the yellow LED 106 turns off and the coffee decanter device 12 goes immediately into the Dispense stage or state. According to this aspect, the Brew stage by-pass only occurs when the coffee decanter device 12 is active and in the Brew stage. Pressing the Reset button 414 at any other time initiates a restart for the microprocessor 100. By-passing the Brew, Dispense and Expiry Stages can done by pressing and holding the Reset button 414 for 4 seconds or by receiving a wireless signal from the coffee maker device 14. When this is done, the LED's 106, 108, 110 to flash briefly and then go out.

The Dispense/Freshness Stage is indicated primarily by the green LED 108. As the timer function for the Brew Stage completes, the firmware executing on the microprocessor 100 turns off the yellow LED 106 and blinks the green LED 108 every 2 seconds. The blinking green LED 108 indicates that the brew is Fresh and can be dispensed. The duration of the dispense/freshness stage is dependant on the pre-programmed values for the particular customer or preference. The Dispense/Freshness stage may be by-passed by pressing and holding the Reset switch 414 for 2 seconds. In wireless mode, the Dispense stage is by-passed by a transmitting a command via the communication link 16 by coffee maker device 14. If the Dispense/Freshness Stage is cancelled, the coffee decanter device 12 goes to the Inactivity Stage and remains inactive unit a reset is received.

The expiry or advisory stage follows the Dispense/Freshness stage and is indicated by actuation of the red LED 110 (FIG. 2) on the decanter device 12 (and the red LED 210 on the coffee maker device 14). As the timing loop or function finishes for the Dispense/Freshness stage, the microprocessor 100 (200) turns off the green LED 108 (208) and blinks the red LED 110 (210), in the present embodiment the blinking is every 2.5 seconds for 36 minutes. The time period for the Expiry stage is programmed in firmware and may include a number of pre-programmed values which are selected by a customer or for a particular application, for example, a duration from 24:01 to 60:00 minutes as shown below in the Tables. The Expiry stage may be cancelled by pressing the reset button 414 (FIG. 4(c)) on the decanter device 12 and holding it down for 2 seconds. The Expiry stage may also be cancelled by a command sent to the decanter device 12 from the coffee maker device 14 via the wireless communication link 16 (FIG. 1). In response, the microprocessor 100 resets the timer function and enters the Inactivity stage.

After the microprocessor 100 completes the timer function for the Expiry stage, the decanter device 12 enters the Inactivity stage. The Inactivity stage comprises a ‘sleep’ or energy conservation mode, which includes turning off the LEDs 106, 108, 110. The microprocessor 100 keeps the decanter device 12 in the Inactivity stage until a new Brew cycle is initiated by pressing the reset button 414 (FIG. 4(a)) or receiving a command or reset signal via the communication link 16 from the coffee maker device 14, for example, in response to the brew button 3(FIG. 1) being activated on the coffee maker 1.

The End-of-Life stage indicates that the battery 116 (FIG. 2) is near the end of its useable life. For example, the microprocessor 100 uses an input port to take a voltage level reading for the battery 116 and when the voltage level falls below a pre-determined threshold, the microprocessor 100 under firmware control initiates a function for the End-of-Life stage. If a brew cycle is initiated during the End-of-Life stage, the microprocessor 100 blinks all of the LEDs 106, 108, 110 at a rapid rate, for example, 125 milliseconds for 5 seconds from the start of the brew cycle. If the user continues with the brew cycle, the microprocessor 100 attempts to maintain operation, but on each cycle sequence the relevant LED, for example the green LED 108 for the Dispense stage is turned on in solid state instead of a blinking state as during normal operation. This way the LED 106, 108 or 110 provides an indication to user that the battery 116 needs to be replaced soon. In addition, an audible indication may be issued by the microprocessor 110 actuating the buzzer 104.

As described above, the housing 402 for the decanter clip 400 (FIG. 4) ermetically sealed as is required by the food and beverage industry. Because the ice 12 is hermetically sealed, the battery 116 cannot be recharged or replaced the device is disposed.

Life expectancy of the decanter device 12 is based on the particular application and the usage pattern. It is estimated that if used 24 hours a day and 7 days a week, the useable life is approximately 1 year.

Exemplary timer functions for the operational stages as described above are provided below in Tables I, II and III.

TABLE I
Timer Stages (Default Parameters)

| Stage | Time/Minutes | Description | LED Sequence |
|---|---|---|---|
| 1 | 0:00-4:00 | Brew Cycle | Yellow |
| 2 | 4:01-24:00 | Dispense Cycle | Green |
| 3 | 24:01-60:00 | Expiry Cycle | Red |
| 4 | 60:01- | Sleep/Reset Cycle | NONE |
| 5 | | End-of-Life | All Leds - 125 ms |

TABLE II
Complete Time Sequence for Non By-Pass Version 1.0.0

| | | | | Led Pulse |
|---|---|---|---|---|
| Stage | Sub | Time | Description | Sequence |
| 1 | | 0:01-4:00 | Start - Brew Cycle | All Leds |
| | | | | Yellow - |
| | | | | 2000 ms |
| | A | | Bypass to Dispense Cycle | Red, Green - |
| | | | | 125 ms |
| | B | | Bypass to End of Cycle | All Leds - |
| | | | | 125 ms |
| 2 | | 4:01-20:00 | Dispense Cycle | Green - |
| | | | | 2000 ms |
| | A | | Bypass to Expiry Cycle | Red, Green - |
| | | | | 125 ms |
| | B | | Bypass to Inactivity Cycle | All Leds - |
| | | | | 125 ms |
| 3 | | 24:01-60:00 | Expiry Cycle | Red - 2500 ms |
| | A | | Bypass to Inactivity Cycle | Red, Green - |
| | | | | 125 ms |
| 4 | | 60:00- | Inactivity Cycle | NO LEDS |
| 5 | | | End-of-Life | All Leds - |
| | | | | 125 ms |

Note
Sub A - The Reset Button is pressed and held down for 2000 ms
Sub B - The Reset Button is pressed and held down for 4000 ms (optional)

TABLE III
Complete Time Sequence for By-Pass Version 1.0.0

| Stage | Sub | Time | Description | Led Pulse Sequence |
|---|---|---|---|---|
| 1 | | 0:01-4:00 | Start-Brew Cycle | Yellow-2000 ms |
| | C | | Bypass to Start-Brew | All Leds-125 ms |
| | | | Cycle | |
| 2 | | 4:01-20:00 | Dispense Cycle | Green-2000 ms |
| | C | | Bypass to Start Brew | All Leds-125 ms |
| | | | Cycle | |
| 3 | | 24:01-60:00 | Expiry Cycle | Red-2500 ms |
| | C | | Bypass to Start-Brew | All Leds-125 ms |
| | | | Cycle | |
| 4 | | 60:00- | Inactivity Cycle | NO LEDS |
| 5 | | | End-of-Life | All Leds-125 ms |

Note:
Sub C-The Reset Button is pressed to Start-Brew Cycle

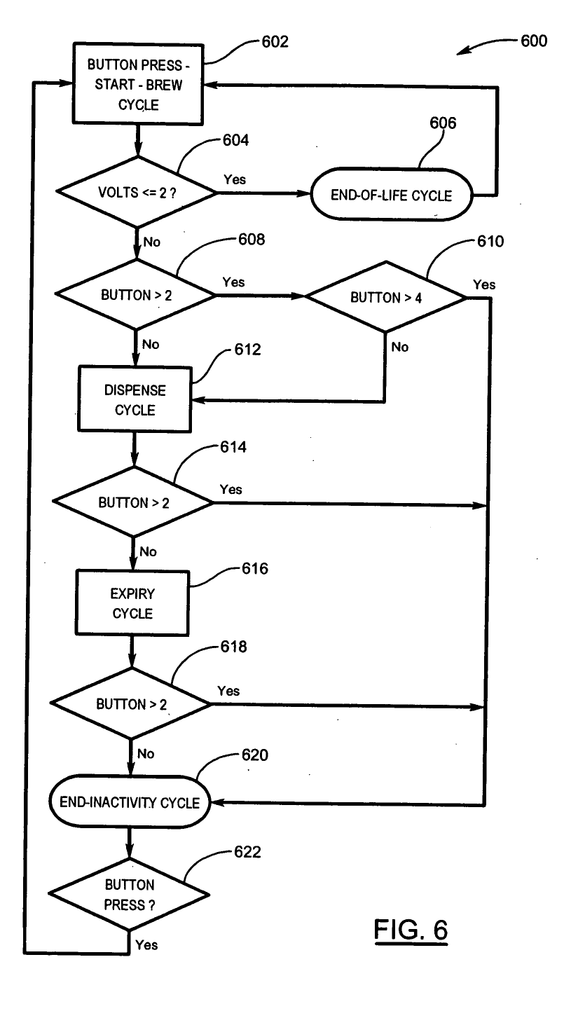

The operation of the decanter device 12 in manual mode is further illustrated by the flow-chart shown in FIG. 6. As shown in block 602, a Brew Cycle is started by pushing the button 414 (FIG. 4(a)) on the device 12 which actuates the reset switch 112 (FIG. 2). If it is determined in decision block 604, that the voltage for the battery 116 (FIG. 2) is less than a threshold, e.g. 2 volts, then an End of Cycle state is entered (block 606). In the End of Cycle state (block 606), the LEDs 106, 108, 110 are rapidly blinked to indicate that the battery needs to be replaced. Next the pressing of the button 414 is scanned, and a check is made to determine if the button 414 was pressed for more than 2 seconds (decision block 608). If the button 414 was pressed for more than 2 seconds, then another check is made to determine if the button 414 was pressed for more than 4 seconds (decision block 610). If the button 414 was not pressed for more than 2 seconds or more than 4 seconds, then timing for the Dispense Cycle is performed (block 612). If the button 414 was pressed for more than 4 seconds (decision block 610), then the Dispense Cycle (block 612) and the Expiry Cycle (block 616) are bypassed, and the InActivity Cycle (block 620) is entered. The timing for the Dispense Cycle is continued until expiry of the Dispense Cycle, or activation of the button (decision block 614). The button 414 (decision block 614) is pressed, for example, if the beverage has been consumed and a brew cycle for a new batch is started. If the button 414 has not been pressed before the expiry of the Dispense Cycle (block 612), then timing for the Expiry Cycle is commenced in block 616, and indicates that the beverage remaining in the decanter 5 (FIG. 1) has exceeded its freshness period, and should not be consumed. The Expiry Cycle (block 616) is terminated by pressing the button 414 (decision block 618), i.e. to start a brew cycle for a new beverage, or allowed to time-out followed by the InActivity Cycle (block 620). The InActivity Cycle (block 620) is terminated or exited if the button 414 is pushed (decision block 622). For each of the cycles, the timing is implemented in firmware, for example, a timing loop, a count-down timer, and the timing duration is programmable and modifiable based on the type of beverage or mixture being prepared. In addition at one or more of the stages, the LEDs 106, 108, 110 and/or the buzzer 104 are activated as described above, or according to another sequence or order which is programmed in firmware for the microcontroller 100.

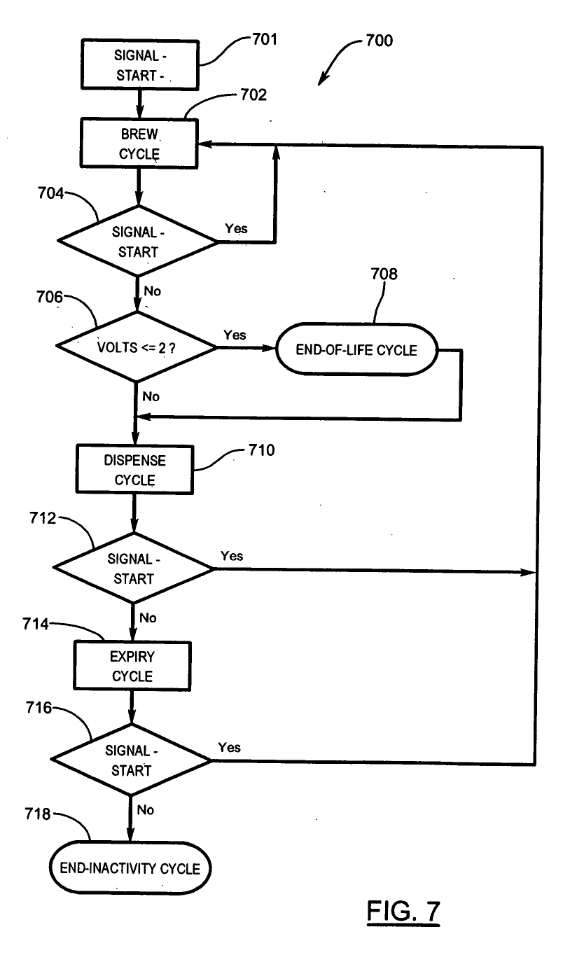

Reference is also made to FIG. 7 which shows operation of the decanter device 12 in wireless mode in the form of a method indicated generally by reference 700. Operation in wireless mode is similar to operation in manual mode (FIG. 6) with the exception that a Start Signal is provided/received via the wireless communication link 16 (FIG. 1). As shown in FIG. 7, a Start Signal is received in block 701, and timing for the Brew Cycle is performed (block 702). Receiving a Start Signal as determined in decision block 704 also starts the Brew Cycle (block 702). In decision block 706, a check is made of the voltage level for the battery 116 (FIG. 2). If the battery voltage is less than 2 Volts, then the battery 116 needs to be replaced and the End-of-Life Cycle state is entered in block 708. As described above, the LEDs 106,108, 110 may be flashed to provide a visual indication. Following the Brew Cycle, timing for the Dispense (or Freshness) Cycle is commenced in block 710. If a Start Signal is not received by the end of the Dispense Cycle as indicated by decision block 712, then the Expiry Cycle is commenced (block 714). The Expiry Cycle is terminated if a Start Signal is received (decision block 716) to start a Brew Cycle (block 702). If a Start Signal is not received (decision block 716) within a predetermined period (for example programmed in firmware), the InActivity Cycle is entered in block 718. As described above, the LEDs 106, 108, 110 and/or the buzzer 104 may be activated in conjunction with the various cycles.

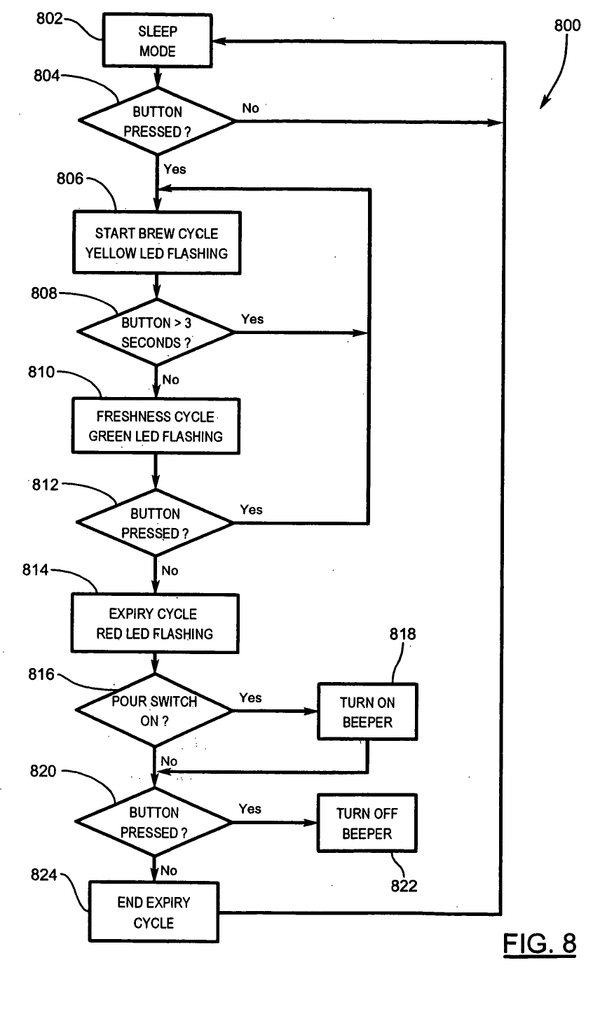

Reference is made to FIG. 8, which shows an operating process for the decanter device 12 with the optional pour switch 114 (FIG. 2) and buzzer 104 (FIG. 3) devices installed. The operating process is indicated generally by reference 800. The device 12 remains in a Sleep Mode or idle state (block 802) until the button 414 (FIG. 4(a)) is pressed. In the Sleep Mode, the LEDs 106, 108, 110 (FIG. 2) are turned OFF. The pressing of the button 414 is determined in decision block 804. Once the button 414 is pressed a “Start Brew Cycle” is initiated and the yellow LED 106 (FIG. 2) begins flashing (block 806). Pushing the button 414 for more than 3 seconds, as determined in decision block 808, causes the Brew Cycle to be bypassed. At this step, a single beep may also be generated using the buzzer 104 (FIG. 3). Following timing of the Brew Cycle (block 806), timing for the Freshness Cycle is initiated (block 810) and continued until expiry of the Freshness Cycle, or activation of the button (decision block 812). The button 414 (decision block 812) is pressed, for example, if the beverage has been consumed and a brew cycle for a new batch is started. If the button 414 has not been pressed before the expiry of the Freshness Cycle (block 810), then timing for the Expiry Cycle is commenced in block 814, and includes activating, e.g. flashing, the red LED 110 (FIG. 2). In block 814, a beep may be generated once every second using the buzzer 104 (FIG. 2). If the pour switch 114 is activated (decision block 816), i.e. indicating the pouring of the beverage, then a continuous beep is sounded on the buzzer 104 as indicated in block 818, for example to warn the user that the beverage being poured is past its freshness. Pressing the button 414 (decision block 820) stops the continuous beep on the buzzer 104 (block 822) and the device 12 goes into Sleep Mode (block 802). If the button 414 is not pressed, the Expiry Cycle is timed out in block 824, and then the device 12 goes into Sleep Mode (block 802).

The present invention may be embodied in other specific forms without departing from the spirit or essential characteristics thereof. Other adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

1. A timer device for a container holding a beverage, said timer device comprising:
a base member for coupling to the container;
a housing member adapted for coupling to said base member; and
a controller contained in said housing member, and including a timer component for measuring an elapsed time for the beverage, wherein said timer component includes an input for receiving a start signal; and
said controller including a power supply input.

2. The timer device as claimed in claim 1, wherein said start signal comprises a signal generated by a reset switch.

3. The timer device as claimed in claim 1, wherein said start signal comprises a command signal received from another device.

4. The timer device as claimed in claim 3, wherein said command signal is transmitted via a wireless communication link.

5. The timer device as claimed in claim 3, further including a display component, said display component being coupled to an output on said controller, and said controller including a component for activating said display component to display the elapsed time for the beverage.

6. The timer device as claimed in claim 5, further including an audio device, said audio device being coupled to an output on said controller, and said controller including a component for activating said audio device to provide an audible indication of a freshness state for the beverage.

7. The timer device as claimed in claim 6, further including a plurality of indicator devices, each of said indicator devices being coupled to an output on said controller, and said controller including a component for activating said indicator devices to provide a visible indicator of a freshness state for the beverage.

8. The timer device as claimed in claim 7, wherein said controller includes a component for activating said indicator devices to provide a visible indication of stages in a brew cycle for the beverage.

9. The timer device as claimed in claim 5, further including a pour switch, said pour switch being a coupled to an input on said controller, and said pour switch generating an output signal when the container is tilted to pour the beverage, and said controller including a component for inputting the output signal from said pour switch.

10. The timer device as claimed in claim 5, further including a power supply indicator coupled to an output on said controller, said controller including a component for activating said power supply indicator to indicator a low power supply level.

11. The timer device as claimed in claim 1, further including a communication interface, said communication interface being coupled to said controller and being responsive to signals from said controller for receiving and transmitting data to another device.

12. A system for monitoring a brewed beverage dispensed from a container, said system comprising:
a timer device including,
a housing for coupling to the container;
a controller contained in said housing, and including a timer component for measuring an elapsed time for the beverage, wherein said timer component includes an input for receiving a start signal;
a communication interface coupled to said controller, and said controller including a component for processing command signals received via said communication interface; and
a controller module including,
a controller device having an input port coupled to a fill switch, said fill switch outputting a signal, said controller device having a component responsive to said fill switch signal for generating said start signal for said timer device;
a communication interface coupled to said controller device, and said controller device including a component for transmitting said start signal to said timer device.

13. The system as claimed in claim 12, wherein said controller includes a component for transmitting a signal for said elapsed time via said communication interface.

14. The system as claimed in claim 12, wherein said timer device includes a pour switch, said pour switch being a coupled to an input on said controller, and said pour switch generating an output signal when the container is tilted to pour the beverage, and said controller including a component for inputting the output signal from said pour switch and generating a pour signal for transmission via said communication signal.

15. The system as claimed in 14, further including a data processing unit having a communication interface, said communication interface executing a communication protocol compatible with said communication interface for said timer device or said controller module for receiving and transmitting signals, and said data processing unit including a component for processing said elapsed time signal and said pour signal.

16. The system as claimed in claim 15, wherein said data processing unit includes a component for generating command signals for transmission to said timer device or to said controller module.

17. The system as claimed in claim 12, wherein said controller module includes a display component, said display component being coupled to an output on said controller device, and said controller device including a component for activating said display component to display the elapsed time for the beverage.

18. The system as claimed in claim 17, wherein said controller module includes an audio device, said audio device being coupled to an output on said controller device, and said controller device including a component for activating said audio device to provide an audible indication of a freshness state for the beverage.

19. A device for monitoring a beverage in a container, said device comprising:
a base member for coupling to the container;
a housing member adapted for coupling to said base member;
a circuit contained in said housing member, and including a timer component for determining a freshness state for the beverage, wherein said timer component includes an input responsive to a start signal; and
said circuit including a power supply input.

20. The device as claimed in claim 19, wherein said circuit includes a display component, and a component for activating said display component to display the freshness state for the beverage.

21. The device as claimed in claim 20, wherein said circuit includes an audio device, and a component for activating said audio device to provide an audible indication of the freshness state for the beverage.

22. The device as claimed in claim 21, wherein said display component comprises a plurality of indicator devices, and said circuit includes a component for activating said indicator devices to provide a visible indicator of the freshness state for the beverage.

23. The device as claimed in claim 22, further including a faceplate for sound housing member, said faceplate having openings in communication with said indicator devices, and said faceplate including markings associated with said indicator devices and said markings providing information related to the freshness state.

24. The device as claimed in claim 23, wherein said faceplate includes advertising indicia.
